(19) United States
(12) Patent Application Publication
(10) Pub. No.: US 2024/0357968 A1
(43) Pub. Date: Oct. 31, 2024

(54) SENSOR SUPPORT SYSTEM FOR A HARVESTING IMPLEMENT OF AN AGRICULTURAL HARVESTER

(71) Applicant: CNH Industrial America LLC, New Holland, PA (US)

(72) Inventors: Cory Douglas Hunt, II, Millersville, PA (US); Bart Lenaerts, Zutendaal (BE); Bart M.A. Missotten, Herent (BE); Joseph Russell Woelfling, Landisville, PA (US)

(21) Appl. No.: 18/685,993

(22) PCT Filed: Aug. 22, 2022
(86) PCT No.: PCT/US22/41040

§ 371 Date: Feb. 23, 2024

Related U.S. Application Data
(60) Provisional application No. 63/235,885, filed on Aug. 23, 2021.

(51) Int. Cl. A01D 41/14; A01D 41/127

(52) U.S. Cl. CPC A01D 41/14; A01D 41/127

(57) ABSTRACT

A harvesting implement for an agricultural harvester includes an implement frame defining a plane extending in a longitudinal direction between forward and aft ends of the frame and in a lateral direction between first and second sides of the implement frame. Additionally, the harvesting implement includes a support arm coupled to the implement frame and a sensor coupled to the support arm. The support arm is, in turn, configured to rotate relative to the implement frame about an axis, intersecting the plane, between a first position at which the sensor has a field of view directed at a portion of the field forward of the harvesting implement and a second position at which a distance between the sensor and the aft end of the implement frame in the longitudinal direction is less than when in the first position.

### FIELD OF THE INVENTION

The present disclosure generally relates to harvesting implements for agricultural harvesters and, more particularly, to a sensor support system for a harvesting implement of an agricultural harvester.

### BACKGROUND OF THE INVENTION

An agricultural harvester is a machine used to harvest and process crops growing within a field. For example, a combine harvester is a type of harvester used to harvest grain crops, such as wheat, oats, rye, barely, corn, soybeans, and/or the like. In general, most harvesters are equipped with a detachable harvesting implement, such as a header. In this respect, as the harvester travels across the field, the harvesting implement cuts and collects the crop from the field and feeds it to the base harvester for further processing.

When performing a harvesting operation, the harvesting implement is positioned at a predetermined height above the field surface. Such positioning, in turn, permits a cutter bar mounted on the harvesting implement to sever the crops present within the field from the associated stubble at a desired cutting height. As the harvester travels across the field to perform the harvesting operation, the contour or topography of the field may vary. As such, many harvesting implements include sensors that detect the field contour/topography changes. In this respect, systems for mounting or otherwise supporting sensors relative to the harvesting implement have been developed. While such systems work well, improvements are needed.

Accordingly, an improved sensor support system for a harvesting implement of an agricultural harvester would be welcomed in the technology.

### SUMMARY OF THE INVENTION

Aspects and advantages of the technology will be set forth in part in the following description, or may be obvious from the description, or may be learned through practice of the technology.

In one aspect, the present subject matter is directed to a harvesting implement for an agricultural harvester. The harvesting implement includes an implement frame defining a plane extending in a longitudinal direction between a forward end of the implement frame and an aft end of the implement frame. The plane further extends in a lateral direction between a first side of the implement frame and a second side of the implement frame, with the lateral direction extending perpendicular to the longitudinal direction. Furthermore, the harvesting implement includes a cutter bar supported on the implement frame, with the cutter bar configured to sever crops present within a field across which the agricultural harvester is traveling in a forward direction of travel. Additionally, the harvesting implement includes a support arm coupled to the implement frame and a sensor coupled to the support arm. The support arm is, in turn, configured to rotate relative to the implement frame about an axis, intersecting the plane, between a first position at which the sensor has a field of view directed at a portion of the field forward of the harvesting implement relative to the forward direction of travel and a second position at which a distance between the sensor and the aft end of the implement frame in the longitudinal direction is less than when in the first position.

In another aspect, the present subject matter is directed to a sensor support system for a harvesting implement of an agricultural harvester. The sensor support system includes an implement frame defining a plane extending in a longitudinal direction between a forward end of the implement frame and an aft end of the implement frame. The plane further extends in a lateral direction between a first side of the implement frame and a second side of the implement frame, with the lateral direction extending perpendicular to the longitudinal direction. Moreover, the sensor support system includes a cutter bar supported on the implement frame, with the cutter bar configured to sever crops present within a field across which the agricultural harvester is traveling in a forward direction of travel. In addition, the sensor support system includes a support arm coupled to the implement frame and a sensor coupled to the support arm. The support arm is, in turn, configured to rotate relative to the implement frame about an axis, intersecting the plane, between a first position at which the sensor has a field of view directed at a portion of the field forward of the harvesting implement relative to the forward direction of travel and a second position at which a distance between the sensor and the aft end of the implement frame in the longitudinal direction is less than when in the first position.

These and other features, aspects and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a partial sectional side view of one embodiment of an agricultural harvester in accordance with aspects of the present subject matter;

FIG. 2 illustrates a top view of one embodiment of a harvesting implement of an agricultural harvester in accordance with aspects of the present subject matter;

FIG. 3 illustrates a side view of one embodiment of sensor support system for a harvesting implement of an agricultural harvester in accordance with aspects of the present subject matter, particularly illustrating the sensor support system at a first position;

FIG. 4 illustrates another side view of the embodiment of sensor support system shown in FIG. 3, particularly illustrating the sensor support system at a second position;

FIG. 5 illustrates a perspective view of one embodiment of a linkage of a sensor support system for a harvesting implement in accordance with aspects of the present subject matter, particularly illustrating the linkage when the sensor support system is at a first position;

FIG. 6 illustrates a perspective view of the embodiment of the linkage shown in FIG. 5, particularly illustrating the linkage when the sensor support system is at a second position;

FIG. 7 illustrates a perspective view of another embodiment of a linkage of a sensor support system for a harvesting implement in accordance with aspects of the present subject matter, particularly illustrating the linkage when the sensor support system is at a first position;

FIG. 8 illustrates a perspective view of the embodiment of the linkage shown in FIG. 7, particularly illustrating the linkage when the sensor support system is at a second position.

Repeat use of reference characters in the present specification and drawings is intended to represent the same or analogous features or elements of the present technology.

### DETAILED DESCRIPTION OF THE DRAWINGS

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to a sensor support system for a harvesting implement of an agricultural harvester. Specifically, the harvesting implement includes an implement frame configured to support one or more components of the harvesting implement and/or the sensor support system. The implement frame, in turn, defines a plane extending in a longitudinal direction between the forward and aft ends of the frame and in a lateral direction between first and second sides of the implement frame. Furthermore, harvesting implement includes a cutter bar supported on the implement frame. In this respect, as the agricultural harvester travels across the field, the harvesting implement cuts and collects the crop from the field and feeds it to the base harvester for further processing.

In several embodiments, the disclosed sensor support system includes a support arm coupled to the implement frame and a sensor (e.g., a transceiver-based sensor, such as a LIDAR or RADAR sensor) coupled to the support arm. The support arm is, in turn, configured to rotate relative to the implement frame about an axis, intersecting the plane, between a first position and a second position. Specifically, when the support arm at the first position, the sensor has a field of view directed at a portion of the field forward of the harvesting implement. Conversely, when the support arm is at the second position, the distance between the sensor and the aft end of the implement frame in the longitudinal direction is less than when in the first position. In some embodiments, when the support arm in the second position, the sensor may be positioned aft of the cutter bar and/or forward of the aft end of the implement frame. As such, the overall width of the harvesting implement and the sensor support system in the longitudinal direction is narrower in the second position than in the first position. For example, the sensor support system may include a manually actuated or actuator actuated linkage configured to rotate the support arm between the first and second positions.

The disclosed sensor support system improves the operation of the harvesting implement and the associated agricultural harvester. More specifically, the rotatable support arm allows the sensor to be selectively positioned such that the sensor has a field of view directed in front of the harvesting implement, thereby allowing changes in field topography to be detected before the implement encounters such changes. This, in turn, allows more time for the orientation of the harvesting implement to be adjusted to accommodate such topography changes. However, such positioning of the sensor may cause the harvesting implement and the sensor support system to be too wide for trailering behind the harvester when traveling on roads (e.g., between fields). In this respect, the rotatable support arm allows the overall width of the harvesting implement and sensor support system to be selectively reduced, thereby allowing for road transportation of the harvesting implement.

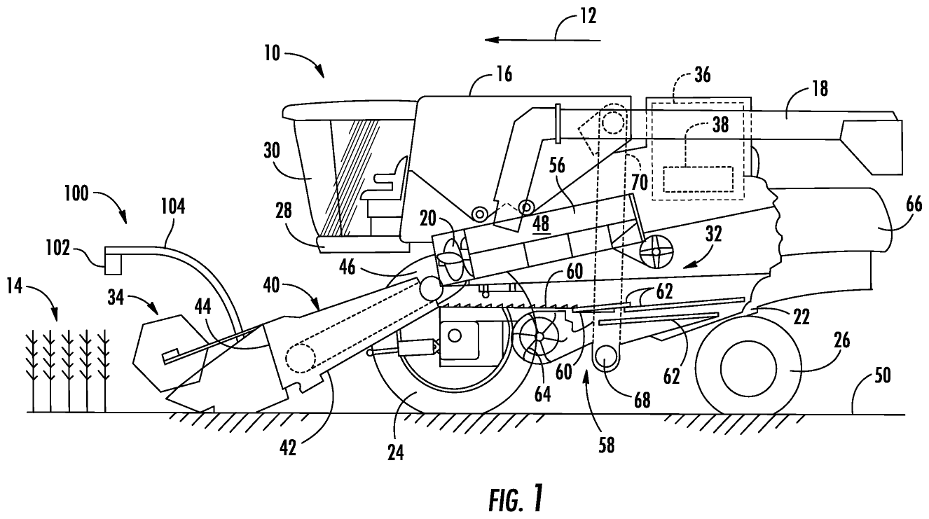

Referring now to the drawings, FIG. 1 illustrates a partial sectional side view of the agricultural harvester 10. In general, the harvester 10 may be configured to travel across a field in a forward direction of travel (indicated by arrow 12) to harvest a crop 14. While traversing the field, the harvester 10 may be configured to process and store the harvested crop within a crop tank 16 of the harvester 10. Furthermore, the harvested crop may be unloaded from the crop tank 16 for receipt by the crop receiving vehicle (not shown) via a crop discharge tube 18 of the harvester 10. Moreover, in the illustrated embodiment, the harvester 10 is configured as an axial-flow type combine in which the harvested crop is threshed and separated while being advanced by and along a longitudinally arranged rotor 20. However, in alternative embodiments, the harvester 10 may have any other suitable harvester configuration, such as a traverse-flow type configuration.

The harvester 10 may include a chassis or main frame 22 configured to support and/or couple to various components of the harvester 10. For example, in several embodiments, the harvester 10 may include a pair of driven, front wheels 24 and a pair of steerable, rear wheels 26 coupled to the frame 22. As such, the wheels 24, 26 may be configured to support the harvester 10 relative to the ground and move the harvester 10 in the forward direction of travel 12. Furthermore, the harvester 10 may include an operator's platform 28 having an operator's cab 30, a crop processing system 32, the crop tank 16, and the crop discharge tube 18 supported by the frame 22. As will be described below, the crop processing system 32 may be configured to perform various processing operations on the harvested crop as the crop processing system 32 transfers the harvested crop between a harvesting implement 34 (e.g., a header) of the harvester 10 and the crop tank 16. Furthermore, the harvester 10 may include an engine 36 and a transmission 38 mounted on the frame 22. The transmission 38 may be operably coupled to the engine 36 and may provide variably adjusted gear ratios for transferring engine power to the wheels 24 via a drive axle assembly (or via axles if multiple drive axles are employed).

Furthermore, as shown in FIG. 1, the harvester 10 includes a feeder 40 that couples to and supports the harvesting implement 34. In general, the harvesting implement 34 cuts or severs a crop growing within a field from its roots or stubble. The sever crop may then be processing and stored on-board the harvester 10 or gathered into a windrow for later collection. More specifically, the feeder 40 may include a feeder housing 42 extending from the forward end 44 to an aft end 46. As such, the forward end 44 of the feeder housing 42 may be coupled to harvesting implement 34. Moreover, the aft end 46 of the feeder housing 42 may be coupled to the frame 22 adjacent to a threshing and separating assembly 48 of the crop processing system 32 such that the harvesting implement 34 may move relative to a field surface 50 in the vertical direction. As will be described below, one or more sensors 102 may capture data indicative of the topography of the field forward of the harvesting implement 34. Such data may, in turn, be used to control the vertical position and/or orientation of the harvesting implement 34 to maintain a constant cutting height.

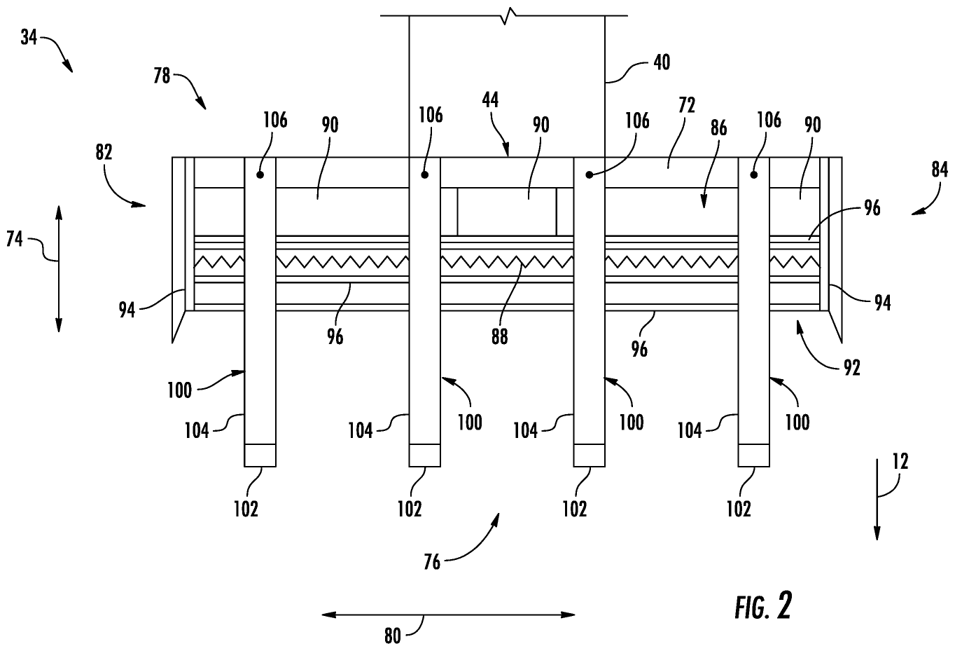

As the harvester 10 is propelled in the forward direction of travel 12 over the field with the crop 14, the crop material is severed from the stubble by a cutter bar 52 (FIG. 2) at the front of the harvesting implement 34. The crop material is delivered to the forward end 44 of the feeder housing 42 (e.g., via a conveyor belt, auger, etc.), which supplies the harvested crop to the threshing and separating assembly 48. In general, the threshing and separating assembly 48 may include a cylindrical chamber 56 in which the rotor 20 is rotated to thresh and separate the harvested crop received therein. That is, the harvested crop is rubbed and beaten between the rotor 20 and the inner surfaces of the chamber 56 to loosen and separate the grain, seed, or the like from the straw.

The harvested crop separated by the threshing and separating assembly 48 may fall onto a crop cleaning assembly 58 of the crop processing system 32. In general, the crop cleaning assembly 58 may include a series of pans 60 and associated sieves 62. In general, the separated harvested crop may be spread out via the oscillation of pans 60 and/or sieves 62 and may eventually fall through apertures defined by the sieves 62. Additionally, a cleaning fan 64 may be positioned adjacent to one or more of the sieves 62 to provide an air flow through the sieves 62 that removes chaff and other impurities from the harvested crop. For instance, the fan 64 may blow the impurities off the harvested crop for discharge from the harvester 10 through the outlet of a straw hood 66 positioned at the back end of the harvester 10. The cleaned harvested crop passing through the sieves 62 may then fall into a trough of an auger 68, which may be configured to transfer the harvested crop to an elevator 70 for delivery to the crop tank 16.

Additionally, one or more sensor support systems 100 may be coupled to the harvesting implement 34. In general, each sensor support system 100 includes a support arm 104 configured to support a sensor 102 relative to the harvesting implement 34. In this respect, and as will be described below, each support arm 104 is, in turn, configured to rotate between a first position and a second position. As shown in FIG. 1, when the support arm(s) 104 is at the first position(s), the sensor(s) 102 has a field(s) of view directed at a portion(s) of the field forward of the harvesting implement 34. Such positioning of the sensor(s) 102 allows for the capture of data indicative of the topography of the field forward of the harvesting implement 34. Conversely, when the support arm(s) 104 is at the second position(s), the overall width of the harvesting implement 34 and the sensor support system(s) 100 is narrower, thereby permitting road transportation of the harvesting implement 34.

Referring now to FIG. 2, the harvesting implement 34 includes an implement frame 72. More specifically, the implement frame 72 extends in a longitudinal direction (indicated by arrow 74) between a forward end 76 of the frame 72 and an aft end 78 of the frame 72. Furthermore, the implement frame 72 extends in a lateral direction (indicated by arrow 80) between a first side 82 of the frame 72 and second side of the frame 72. In this respect, the implement frame 72 defines a plane 86 extending in the longitudinal direction 74 between the forward and aft ends 76, 78 and in the lateral direction 80 between the first and second sides 82, 84. As will be described below, the support arm(s) 104 of the sensor support system(s) 100 is configured to rotate about an axis(es) intersecting the plane 86.

In several embodiments, the implement frame 72 is configured to couple to and/or support one or more components of the harvesting implement 34. For example, the harvesting implement 34 may include a cutter bar 88 supported on the implement frame 72. The cutter bar 88, in turn, is configured to sever crops (e.g., the crop 14 in FIG. 1) present within a field across which the agricultural harvester 10 is traveling in a forward direction of travel 12. Additionally, the harvesting implement 34 may include one or more conveyor belts 90 positioned aft of the cutter bar 88 relative to the forward direction of travel 12. In this respect, the conveyor belt(s) 90 is configured to transport the severed crops from the cutter bar 88 to the forward end 44 of the feeder 40. Moreover, the harvesting implement 34 may include a reel assembly 92 pivotably coupled to the implement frame 72. Specifically, the reel assembly 92 may include one or more reel arms 94 pivotably coupled to the implement frame 72 to allow vertical movement of the reel assembly 92 relative to the frame 72. In addition, the reel assembly 92 may include a plurality of horizontal bars (sometimes referred to as bats) 96 extending between the reel arms 94 and a plurality of vertical teeth or tines (not shown) coupled to the bars 96. In this respect, at the harvester 10 travels across the field, the bars 96 and the tines rotate to knock down and straighten the crop standing in the field for subsequent cutting by the cutter bar 88. However, in alternative embodiments, the implement frame 72 may be configured to support any other suitable components in addition to or in lieu of the components described above. For example, in one embodiment, the implement frame 72 may support an auger (not shown) in lieu of the conveyor belt(s) 90.

Furthermore, one or more sensor support systems 100 are coupled to the implement frame 72. As mentioned above, each sensor support system 100 includes a sensor 102 and a support arm 104. The support arm 104 of each sensor support system 100 is, in turn, rotatably coupled to the implement frame 72. In this respect, each support arm 104 is configured to rotate relative to the implement frame 72 about a corresponding axis 106 intersecting or otherwise extending through the plane 86 defined by the implement frame 72. As will be described below, the support arm(s) 104 can be rotated about the axis(es) 106 to selectively position the sensor(s) 102 such that the sensor(s) 102 have field(s) of view directed at portion(s) of the field forward of the harvesting implement 34 or narrow the width of the harvesting implement 34 in the longitudinal direction 74.

Any suitable number of sensor support systems 100 may be coupled to the harvesting implement 34. For example, in the illustrated embodiment, four sensor support systems 100 are coupled to the implement frame 72. In such an embodiment, the sensor support systems 100 are spaced apart from each other along the longitudinal direction 74 such that each sensor 102 can capture data indicative of different portion of the field in front of the harvesting implement 34. However, in alternative embodiments, one, two, three, or five or more sensor support systems 100 coupled to the harvesting implement 34.

It should be further appreciated that the configuration of the agricultural harvester 10 described above and shown in FIGS. 1 and 2 is provided only to place the present subject matter in an exemplary field of use. Thus, it should be appreciated that the present subject matter may be readily adaptable to any manner of harvester configuration.

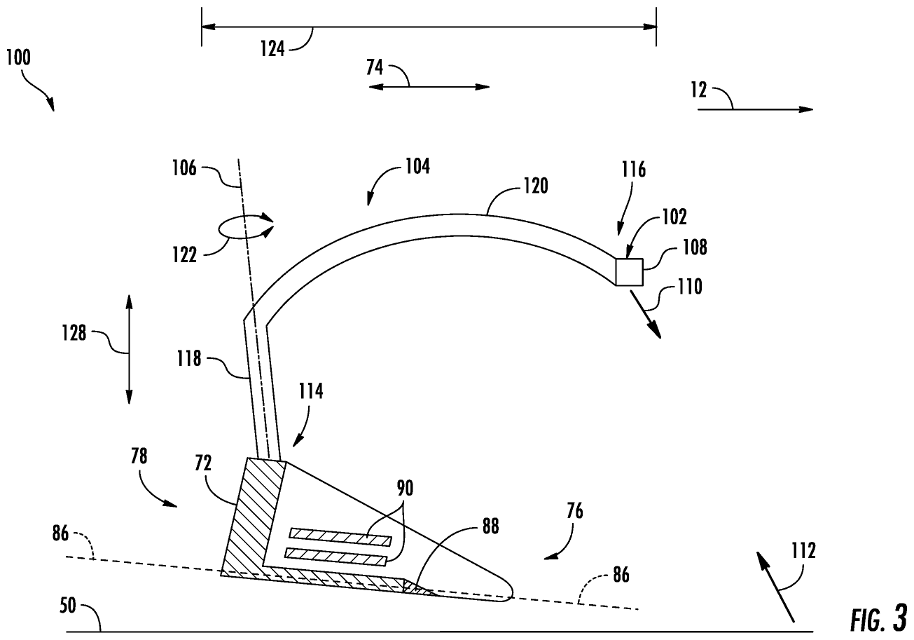

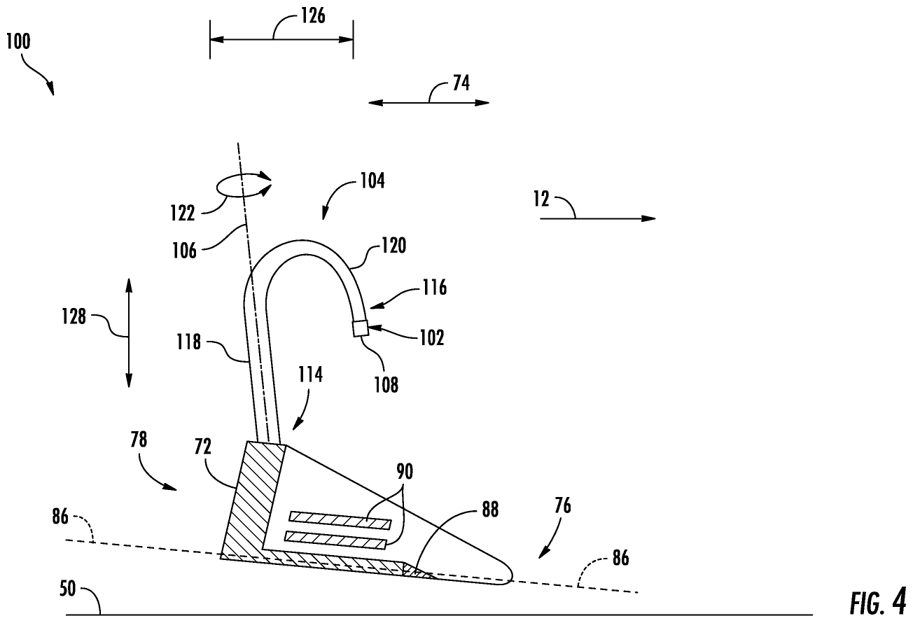

Referring now to FIGS. 3 and 4, differing sides views of one embodiment of a sensor support system 100 for a harvesting implement of an agricultural harvester is illustrated in accordance with aspects of the present subject matter. Specifically, FIG. 3 illustrates the sensor support system 100 when at a first position. Furthermore, FIG. 4 illustrates the sensor support system 100 when at a second position.

In general, the sensor support system 100 will be described herein with reference to the agricultural harvester 10 (and, more specifically, the harvesting implement 34) described above with reference to FIGS. 1 and 2. In this respect, the reel assembly 92 has been omitted from FIGS. 3 and 4 for clarity. However, it should be appreciated by those of ordinary skill in the art that the disclosed sensor support system 100 may generally be utilized with agricultural harvester/harvesting implement having any other suitable configuration.

As shown in FIGS. 3 and 4, the sensor support system 100 includes a sensor 102. In general, the sensor 102 is configured to capture data associated with a portion of the field 50 forward of the harvesting implement 34 relative to the forward direction of travel 12. For example, such captured data may be indicative of the field topography or surface contour of the field in front the harvesting implement 34. As such, the data captured by the sensor 102 may be used to control the position (e.g., the vertical position and/or the fore/aft tilt angle) of the harvesting implement 34 to maintain a constant cutting height.

In several embodiments, the sensor 102 may be configured as a transceiver-based sensor 108. In general, as the agricultural harvester 10 travels across the field, the transceiver-based sensor 108 may be configured to emit one or more output signals (e.g., indicated arrow 110) for reflection off of the portion of the field within its field of view. The output signal(s) 110 may, in turn, be reflected by the field as return signals (e.g., indicated by arrows 112). Moreover, the transceiver-based sensor 108 may be configured to receive the reflected return signals 112. The received return signal(s) 112 may, in turn, be indicative of the topography of the portion of the field off which the return signal(s) 112 are reflected.

The transceiver-based sensor 108 may generally correspond to any suitable sensing device configured to function as described herein, such as by emitting output signals for reflection off of the portion of the field within its field of view and by receiving or sensing the return signals. For example, in several embodiments, the transceiver-based sensor 108 may correspond to a light detection and ranging (LIDAR) sensor configured to emit light/laser output signals for reflection off of the portion of the field present within its field of view. In such an embodiment, the LIDAR sensor may receive the reflected return signals and generate a plurality of data points based on the received return signal(s), with each data point being indicative of the distance between the sensor and the portion of the field off which one of the return signals is reflected. However, in alternative embodiments, the transceiver-based sensor 108 may correspond to a radio detection and ranging (RADAR) sensor, an ultrasonic sensor, or any other suitable type of sensor.

Furthermore, as shown in FIGS. 3 and 4, the sensor support system 100 includes a support arm 104. In general, the support arm 104 is configured to support the sensor 102 relative to the harvesting implement 34. Specifically, in several embodiments, the support arm 104 extends from a first end 114 coupled to the implement frame 72 to a second end 116 coupled to the sensor 102. For example, in some embodiments, the support arm 104 may include a vertical portion 118 positioned adjacent to the first end 114 of the arm 104 such that the portion 118 extends generally upward from the implement frame 72. Moreover, in such embodiments, the support arm 104 may include an arcuate portion 120 extending from the vertical portion 118 to the second end 116 of the arm 104. As will be described below, the support arm 104 is rotatable about the axis 106 (e.g., as indicated by arrow 122 in FIGS. 3 and 4), which intersects the plane 86 (e.g., as indicated by dashed lines 86 in FIGS. 3 and 4). Such rotation, in turn, moves the support arm 104 between the first position illustrated in FIG. 3 and the second position illustrated in FIG. 4. For example, in some embodiments, the sensor support system 100 includes a linkage 123 (FIGS. 5-8) configured to facilitate rotation of the support arm 104 between the first and second positions. However, in alternative embodiments, the support arm 104 may have any other suitable configuration that allows the arm 104 to support the sensor 102 at the first and second positions.

FIG. 3 illustrates the sensor support system 100 when the support arm 104 is at the first position. Specifically, as shown, when the support arm 104 is at the first position, the sensor 102 is positioned such that the sensor 102 has a field of view directed at a portion of the field 50 forward of the harvesting implement 34 relative to the forward direction of travel 12. Such rotational positioning of the support arm 104 relative to the implement frame 72 allows the sensor 102 to capture data associated with a portion of the field 50 in front of the harvesting implement 34. Thus, the sensor 102 can detect changes in field topography before the harvesting implement 34 encounters such changes, thereby allowing more time for the orientation of the harvesting implement 34 to be adjusted to accommodate such topography changes. In one embodiment, when the support arm 104 is at the first position, the sensor 102 is positioned forward of the cutter bar 88 and the forward end 76 of implement frame 72. In this respect, a first distance (indicated by arrow 124) is defined between the sensor 102 and the aft end 78 of the implement frame 72 in the longitudinal direction 74 when the support arm 104 is at the first position. The distance 124, in turn, generally corresponds to the overall width of the harvesting implement 34 and the sensor support system(s) 100 in the longitudinal direction 74. However, in alternative embodiments, the first position may correspond to any other suitable rotational position of the support arm 104 relative to the implement frame 72 that allows the sensor 102 captured data associated with a portion of the field in front of the harvesting implement 34.

Conversely, FIG. 4 illustrates the sensor support system 100 when the support arm 104 is at the second position. In general, the distance between the sensor 102 and the aft end 78 of the implement frame 72 in the longitudinal direction 74 is less when the support arm 104 is at the second position than the first position. Specifically, as shown, when the support arm 104 is at the second position, a second distance (indicated by arrow 126) is defined between the sensor 102 and the aft end 78 of the implement frame 72 in the longitudinal direction 74. The second distance 126 is, in turn, less than the first distance 124 shown in FIG. 3. In this respect, the overall width of the harvesting implement 34 and the sensor support system 100 in the longitudinal direction 74 is narrower when the support arm 104 is at the second position than the first position. Thus, the narrower width of the harvesting implement 34 and the sensor support system 100 at the second position allows for transportation of the harvesting implement 34 on a road, such as when the implement 34 is being trailered behind the harvester 10. In one embodiment, when the support arm 104 is at the second position, the sensor 102 is positioned aft of the cutter bar 88 and the forward end 76 of implement frame 72. Moreover, in such an embodiment, the sensor 102 may also positioned forward of the aft end 78 of implement frame 72 such that the sensor 102 is positioned above the harvesting implement 34. However, in alternative embodiments, the second position may correspond to any other suitable rotational position of the support arm 104 relative to the implement frame 72 that allows for a narrower width of the harvesting implement 34 and the sensor support system 100 than the first position.

Referring again to FIGS. 3 and 4, the support arm 104 may be configured to be extended along the axis 106 relative to the implement frame 72 (e.g., as indicated by arrows 128 in FIGS. 3 and 4) such that the sensor 102 is moveable between a raised position and a lowered position. For example, moving the sensor 102 to the lowered position when the support arm 104 is at the first position locates the sensor 102 closer to the field surface 50, thereby allowing for the collection of more detailed sensor data. However, when the reel assembly 92 is at its maximum vertical position, the support arm 104 and/or the sensor 102 may contact the reel assembly 92 when the support arm 104 rotates from the first position to the second position. In this respect, by moving the sensor 102 to the raised position, the support arm 104 can rotate between the first and second positions without contacting the reel assembly 92 regardless of its vertical position. For example, in one embodiment, the vertical portion 118 of the support arm 104 may telescope or otherwise extend (e.g., via an electric linear actuator or a hydraulic/pneumatic cylinder) to raise and the lower the sensor 102.

Additionally, in some embodiments, the support arm 104 may be coupled to the implement frame 72 independently of the reel assembly 92. In such embodiments, the reel assembly 92 can be raised and lowered relative to the implement frame 72 independently of the support arm 104. As such, raising/lowering the reel assembly 92 does not change or otherwise affect the position of the support arm 104 or the sensor 102 relative to the implement frame 72. Similarly, the support arm 104 can be raised, lowered, and/or rotated relative to the implement frame 72 independently of the reel assembly 92. In this respect, raising/lowering/rotating of the support arm 104 does not change or otherwise affect the position of the reel assembly 92 relative to the implement frame 72.

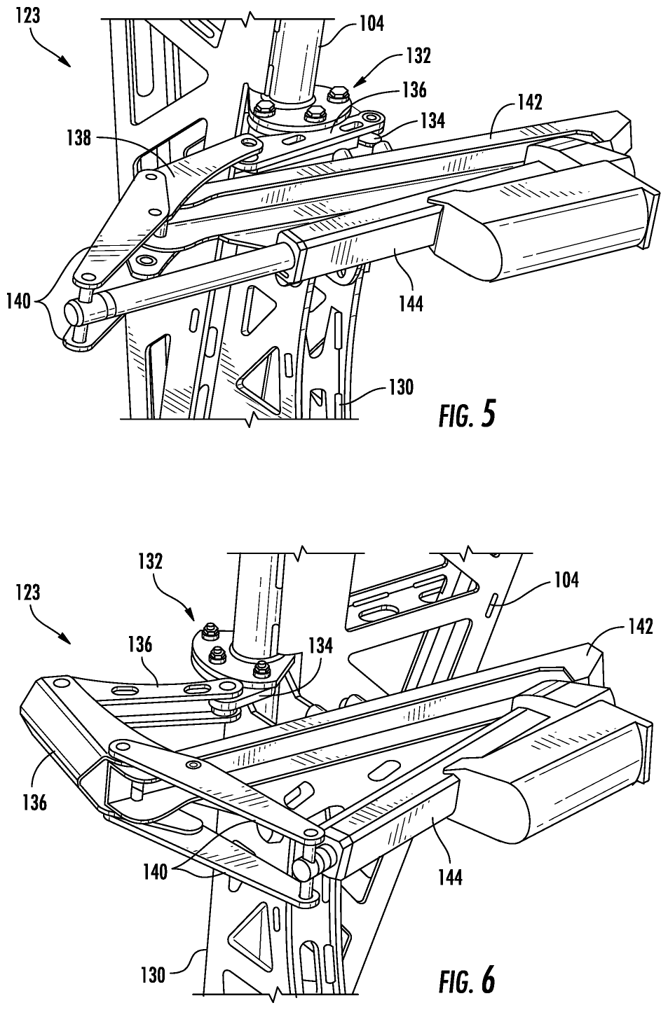

FIGS. 5 and 6 illustrate differing perspective views of one embodiment of the linkage 123. Specifically, FIG. 5 illustrates the linkage 123 when the support arm 104 is at the first position. Moreover, FIG. 6 illustrates the linkage 123 when the support arm 104 is at the second position.

As shown in FIGS. 5 and 6, the linkage 123 include a plurality of links or members that, when actuated, rotate the support arm 104 relative to a post 130, which is, in turn, fixedly coupled to the implement frame 72. Specifically, the support arm 104 is rotatably coupled to the post 130 via a suitable rotational joint 132. In this respect, the linkage 123 may include a rocker arm 134 coupled to the support arm 104 adjacent to the rotational joint 132 such that movement of the rocker arm 134 rotates the support arm 104 relative to the post 130 and the implement frame 72. Furthermore, the linkage 123 may include a first link or member 136 pivotably coupled to the rocker arm 134 and a second link or member 138 pivotably coupled to the first link 136. Additionally, the linkage 123 may include a third link or member 140 and a fourth link or member 142 pivotably coupled to the second link 138 pivotably coupled to the second link 138. Moreover, an actuator 144 may be coupled between the third and fourth links 140, 142. In this respect, as shown in FIG. 5, when the actuator 144 is extended, the linkage 123 rotates the support arm 104 relative to the post 130 and the implement frame 72 to the first position (e.g., as shown in FIG. 3). Conversely, as shown in FIG. 6, when the actuator 144 is retracted, the linkage 123 rotates the support arm 104 relative to the post 130 and the implement frame 72 to the second position (e.g., as shown in FIG. 4).

The actuator 144 may correspond to any suitable type of actuator configured to actuate the linkage 123 such that the support arm 104 is rotated relative to the implement frame 72. For example, in the illustrated embodiment, the actuator 144 is configured as an electric linear actuator. However, in alternative embodiments, the actuator 144 may be configured as a fluid-driven cylinder (e.g., a pneumatic or hydraulic cylinder), a solenoid, and/or the like.

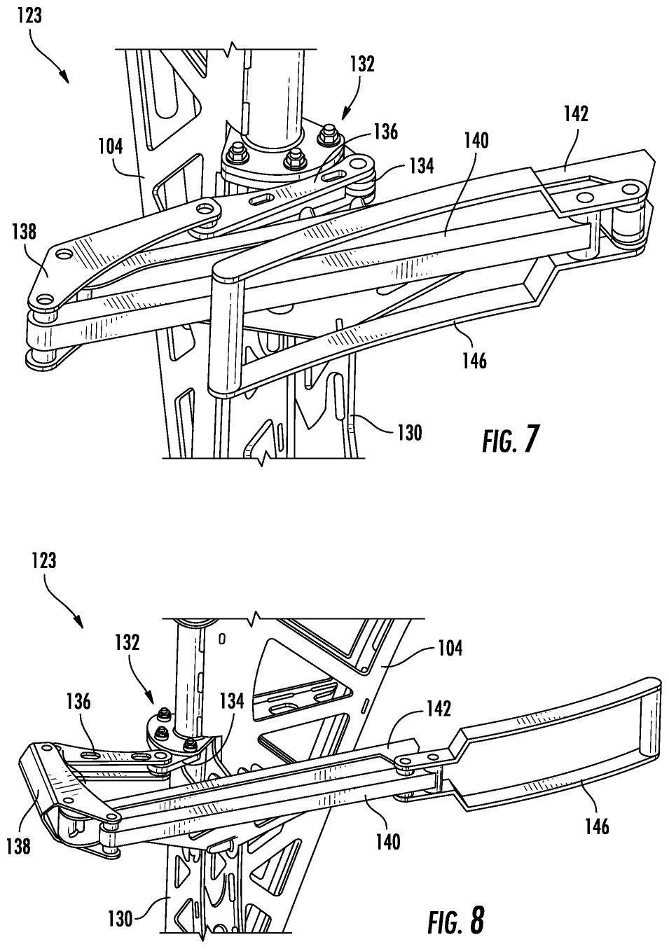

FIGS. 7 and 8 illustrate differing perspective views of another embodiment of the linkage 123. Specifically, FIG. 7 illustrates the linkage 123 when the support arm 104 is at the first position. Moreover, FIG. 8 illustrates the linkage 123 when the support arm 104 is at the second position.

The linkage 123 of FIGS. 7 and 8 is configured similarly to the linkage 123 shown in FIGS. 5 and 6. For example, like the linkage 123 of FIGS. 5 and 6, the linkage 123 shown in FIGS. 7 and 8 includes the rocker arm 134, the first link 136, the second link 138, the third link 140, and the fourth link 142. However, unlike the linkage 123 of FIGS. 5 and 6, the linkage 123 shown in FIGS. 7 and 8 is manually actuatable. In this respect, the linkage 123 shown in FIGS. 7 and 8 includes a handle 146 coupled between the third and fourth links 140, 142. In this respect, as shown in FIG. 7, when the handle 146 is moved toward the second link 138, the linkage 123 rotates the support arm 104 relative to the post 130 and the implement frame 72 to the first position (e.g., as shown in FIG. 3). Conversely, as shown in FIG. 8, when the handle 146 is moved away the second link 138, the linkage 123 rotates the support arm 104 relative to the post 130 and the implement frame 72 to the second position (e.g., as shown in FIG. 4).

In alternative embodiments, the linkage 123 may have any suitable configuration, such as any other suitable number of links. Additionally, in further embodiments, the support arm 104 may be rotatably coupled to the implement frame 72 in any other suitable manner.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1. A harvesting implement for an agricultural harvester, the harvesting implement comprising:
an implement frame defining a plane extending in a longitudinal direction between a forward end of the implement frame and an aft end of the implement frame, the plane further extending in a lateral direction between a first side of the implement frame and a second side of the implement frame, the lateral direction extending perpendicular to the longitudinal direction;
a cutter bar supported on the implement frame, the cutter bar configured to sever crops present within a field across which the agricultural harvester is traveling in a forward direction of travel;
a support arm coupled to the implement frame; and
a sensor coupled to the support arm,
wherein the support arm is configured to rotate relative to the implement frame about an axis, intersecting the plane, between a first position at which the sensor has a field of view directed at a portion of the field forward of the harvesting implement relative to the forward direction of travel and a second position at which a distance between the sensor and the aft end of the implement frame in the longitudinal direction is less than when in the first position.

2. The harvesting implement of claim 1, wherein, when the support arm is at the first position, the sensor is positioned forward of the cutter bar relative to the forward direction of travel.

3. The harvesting implement of claim 1, wherein, when the support arm is at the second position, the sensor is positioned aft of the cutter bar relative to the forward direction of travel.

4. The harvesting implement of claim 3, wherein, when the support arm is at the second position, the sensor is positioned forward of the aft end of the implement frame relative to the forward direction of travel.

5. The harvesting implement of claim 1, further comprising:
a reel assembly coupled to the implement frame such that the reel assembly is moveable relative to the implement frame independently of the support arm.

6. The harvesting implement of claim 1, wherein the support arm is configured to be extended along the axis relative to the implement frame such that the sensor is moveable between a raised position and a lowered position.

7. The harvesting implement of claim 1, further comprising:
a linkage configured to rotate the support arm between the first position and the second position.

8. The harvesting implement of claim 7, wherein the linkage is manually actuatable.

9. The harvesting implement of claim 7, further comprising:
an actuator configured to actuate the linkage to rotate the support arm between the first position and the second position.

10. The harvesting implement of claim 1, wherein the support arm corresponds to a first support arm, the sensor corresponds to a first sensor, the axis corresponds to a first axis, and the portion of the field corresponds to a first portion of the field, the harvesting implement further comprising:
a second support arm coupled to the implement frame and spaced apart from the first support arm in the lateral direction; and
a second sensor coupled to the second support arm,
wherein the second support arm is configured to rotate relative to the implement frame about a second axis intersecting the plane between a first position at which the second sensor has a field of view directed at a second portion of the field forward of the harvesting implement relative to the forward direction of travel and a second position at which a distance between the second sensor and the aft end of the implement frame in the longitudinal direction is less than when in the first position.

11. The harvesting implement of claim 1, wherein the sensor comprises a transceiver-based sensor.

12. The harvesting implement of claim 1, wherein the support arm is arcuate.

13. A sensor support system for a harvesting implement of an agricultural harvester, the sensor support system comprising:
an implement frame defining a plane extending in a longitudinal direction between a forward end of the implement frame and an aft end of the implement frame, the plane further extending in a lateral direction between a first side of the implement frame and a second side of the implement frame, the lateral direction intersecting the longitudinal direction;
a cutter bar supported on the implement frame, the cutter bar configured to sever crops present within a field across which the agricultural harvester is traveling in a forward direction of travel;
a support arm coupled to the implement frame; and
a sensor coupled to the support arm,
wherein the support arm is configured to rotate relative to the implement frame about an axis, intersecting the plane, between a first position at which the sensor has a field of view directed at a portion of the field forward of the harvesting implement relative to the forward direction of travel and a second position at which a distance between the sensor and the aft end of the implement frame in the longitudinal direction is less than when in the first position.

14. The sensor support system of claim 13, wherein, when the support arm is at the first position, the sensor is positioned forward of the cutter bar relative to the forward direction of travel.

15. The sensor support system of claim 13, wherein, when the support arm is at the second position, the sensor is positioned aft of the cutter bar relative to the forward direction of travel.

16. The sensor support system of claim 15, wherein, when the support arm is at the second position, the sensor is positioned forward of the aft end of the implement frame relative to the forward direction of travel.

17. The sensor support system of claim 13, wherein the support arm is configured to be extended along the axis such that the sensor is moveable between a raised position and a lowered position.

18. The sensor support system of claim 13, further comprising:
a linkage configured to rotate the support arm between the first position and the second position.

19. The sensor support system of claim 18, further comprising:
an actuator configured to actuate the linkage to rotate the support arm between the first position and the second position.

20. The sensor support system of claim 13, wherein the sensor comprises a transceiver-based sensor.
